(19) United States
(12) Patent Application Publication
(10) Pub. No.: US 2013/0107912 A1
(43) Pub. Date: May 2, 2013

(54) WLAN Device and Method Thereof

(71) Applicant: Vishakan Ponnampalam, San Jose, CA (US)

(72) Inventor: Vishakan Ponnampalam, San Jose, CA (US)

(21) Appl. No.: 13/512,508

(22) PCT Filed: Jul. 8, 2011
(86) PCT No.: PCT/US11/43339

§ 371 Date: May 29, 2012

Related U.S. Application Data
(60) Provisional application No. 61/362,817, filed on Jul. 9, 2010.

(51) Int. Cl. H04B 1/707

(52) U.S. Cl. CPC H04B 1/707
USPC 375/147; 375/146

(57) ABSTRACT

A Wireless Local Area Network (WLAN) device and a method thereof. The Wireless Local Area Network (WLAN) device generates a Physical Layer (PHY) protocol data unit (PPDU) comprising a preamble field, a header field and a payload field for transmission, and comprises a MAC module, a modulator, and an RF module. The MAC module generates a header data sequence comprising bandwidth information of the transmission. The modulator modulates the header data sequence using S-QPSK modulation to generate the header field of the PPDU. The RF module transmits the header field.

### CROSS REFERENCE TO RELATED APPLICATIONS

This application claims priority of U.S. Provisional Application No. 61/362,817, filed on Jul. 9, 2010, and the entirety of which is incorporated by reference herein.

### BACKGROUND OF THE INVENTION

1. Field of the Invention

The present invention relates to a Future-Generation Wireless Local Area Network WLAN System, and in particular relates to a preamble structure is proposed for the “Signal Field” of the preamble which allows more robust auto detection of a future-generation IEEE 802.11 WLAN radio frame.

2. Description of the Related Art

Wireless communication systems include multiple wireless communication devices that communicate to one another over one or more radio channels. When operating in an infrastructure mode, a wireless communication device, referred to as an access point (AP), provides connectivity with a network, such as the Internet, to other wireless communication devices, such as mobile stations or access terminals (AT). Various examples of wireless communication devices include mobile phones, smart phones, wireless routers, and wireless hubs. In some cases, wireless communication electronics are integrated with data processing equipment such as laptops, personal digital assistants, and computers.

The WLAN systems have become hugely popular over the past decade or so. During this period multiple generations of the WLAN technologies have been introduced, to support the ever increasing demand for high data throughput, made possible through ongoing improvements in semiconductor technology. The WLANs employs orthogonal frequency division multiplexing (OFDM) technology to split a data stream into multiple data substreams, which are to be transmitted over different OFDM subcarriers, referred to as tones or frequency tones. The WLAN systems defined in the Institute of Electrical and Electronics Engineers (IEEE) wireless communications standards comprises various generations of the WLAN technology including IEEE 802.11a, IEEE 802.11n, IEEE 802.11 ac, and IEEE 802.11 for a future generation. To distinguish one data packet of the WLAN generation from another, a WLAN device capable of generating and detecting various generations of the WLAN technology and a method there of is in need.

### BRIEF SUMMARY OF THE INVENTION

A detailed description is given in the following embodiments with reference to the accompanying drawings.

An embodiment of a Wireless Local Area Network (WLAN) device is described, generating a Physical Layer (PHY) protocol data unit (PPDU) comprising a preamble field, a header field and a payload field for transmission, comprising a MAC module, a modulator, and an RF module. The MAC module generates a header data sequence comprising bandwidth information of the transmission. The modulator modulates the header data sequence using S-QPSK modulation to generate the header field of the PPDU. The RF module transmits the header field.

Another embodiment of a WLAN device is provided, receiving data transmission of a Physical Layer (PHY) protocol data unit (PPDU) comprising a preamble field, a header field and a payload field, comprising an RF module and a symbol detector. The RF module receives the PPDU comprising the header field, wherein the header field comprises bandwidth information of the data transmission. The symbol detector determines whether the header field is S-QPSK modulated, and determines the PPDU conforms to a WLAN communication protocol when the header field is S-QPSK modulated.

Yet another embodiment of a method is shown, generating a Physical Layer (PHY) protocol data unit (PPDU) comprising a preamble field, a header field and a payload field for transmission by a WLAN device, comprising a MAC module generating a header data sequence comprising bandwidth information of the transmission; a modulator modulating the header data sequence using S-QPSK modulation to generate the header field of the PPDU; and an RF module transmitting the header field.

Still another embodiment of a method is disclosed, receiving data transmission of a Physical Layer (PHY) protocol data unit (PPDU) comprising a preamble field, a header field and a payload field by a WLAN device, comprising an RF module receiving the PPDU comprising the header field, wherein the header field comprises bandwidth information of the data transmission; a symbol detector determining whether the header field is S-QPSK modulated; and the symbol detector determining the PPDU conforms to a WLAN communication protocol when the header field is S-QPSK modulated.

### BRIEF DESCRIPTION OF THE DRAWINGS

The present invention can be more fully understood by reading the subsequent detailed description and examples with references made to the accompanying drawings, wherein:

FIG. 1 is a system diagram of an exemplary WLAN system 1 conforming to 802.11 ac specification.

FIG. 2 is a block diagram of an exemplary transmitter 2 in a WLAN device according to an embodiment of the invention.

FIG. 3 is a block diagram of an exemplary receiver 3 in a WLAN device according to an embodiment of the invention.

FIG. 4 shows physical layer protocol data formats conforming to legacy 802.11, 802.11n, and 802.11ac specifications.

FIGS. 5A and 5B illustrate modulation schemes employed in the data field conforming to the legacy 802.11 specification.

FIG. 6 illustrates a modulation scheme employed in the HT-SIG field conforming to the 802.11n specification.

FIGS. 7A and 7B illustrate modulation schemes employed in the VHT-SIG field conforming to the current 802.11 ac specification.

FIG. 8 shows a data format for the header field VHT-SIG-A conforming to the 802.11 ac specification according to the invention.

FIGS. 9A and 9B illustrate modulation schemes employed in the VHT-SIG field conforming to the 802.11 communication specification according to an embodiment of the invention.

FIGS. 10A and 10B illustrate another modulation schemes employed in the VHT-SIG field conforming to the 802.11 communication specification according to an embodiment of the invention.

FIG. 11 is a flowchart of an exemplary PPDU generation method 11, generating the header field VHT-SIG-A in the PPDU conforming to the 802.11 communication specification by a WLAN device according to an embodiment of the invention.

FIG. 12 is a flowchart of an exemplary modulation method S1104, performing modulation to the header field VHT-SIG-A by a WLAN device according to an embodiment of the invention.

FIG. 13 is a flowchart of another exemplary modulation method S1104, performing modulation to the header field VHT-SIG-A by a WLAN device according to an embodiment of the invention.

FIG. 14 is a flowchart of an exemplary demodulation method 14, performing demodulation to the header field VHT-SIG-A by a WLAN device according to an embodiment of the invention.

FIG. 15 is a flowchart of another exemplary demodulation method 15, performing demodulation to the header field VHT-SIG-A by a WLAN device according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

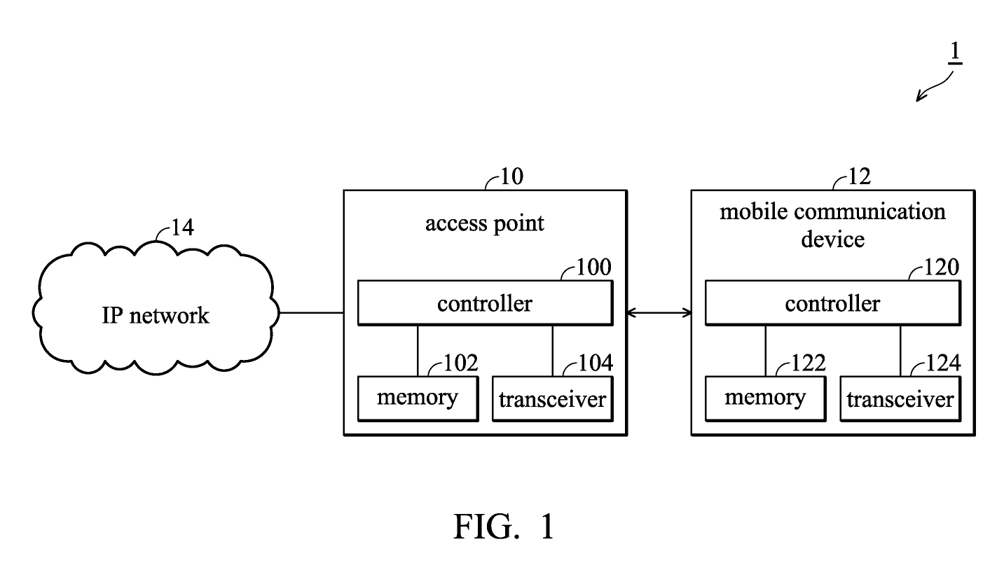

FIG. 1 is a system diagram of an exemplary WLAN system 1 conforming to 802.11 communication standard. FIG. 1 shows the WLAN system 1 with two WLAN devices and an Internet Protocol (IP) network 14. The two WLAN devices include an access point 10 and a mobile communication device 12. The access point 10 comprises a controller 100, a memory 102, and a transceiver 104, wherein the controller 100 is coupled to the memory 102 and transceiver 104. Similarly, the mobile communication device comprises a controller 120, a memory 122, and a transceiver 124, wherein the controller 120 is coupled to the memory 122 and the transceiver 124. The mobile communication device 12 can access external IP network 14 such as the Internet through the access point 10. The access point 10 and the mobile communication device 12 communicate to each other by exchanging communication messages between the transceivers 104 and 124. The transceivers 104 and 124 may comprise separated or integrated transmitter and receiver circuitry, and may comprise one or more transmitter and receiver circuitry. In some implementations, the transceivers 104 and 124 comprise baseband units (not shown) and analog units (not shown) to transmit and receive RF signals. The baseband unit may comprise hardware to perform baseband signal processing including digital signal processing, coding and decoding, modulation, demodulation, and so on. The analog unit may comprise hardware to perform analog to digital conversion (ADC), digital to analog conversion (DAC), filtering, gain adjusting, up-conversion, down-conversion, and so on. The analog unit may receive RF signals from the access point 10 and down-convert the received RF signals to baseband signals to be processed by the baseband unit, or receive baseband signals from the baseband unit up-convert the received baseband signals to RF wireless signals for uplink transmission. The analog unit comprises a mixer to up-convert the baseband signals and down-convert the RF signals with a carrier signal oscillated at a radio frequency of the WLAN system 1. The radio frequency may be 2.4 GHz or 5 GHz utilized in WLAN systems conforming to 802.11a/b/g/n/ac specifications, or others depending on the radio access technology (RAT) of the future generation WLAN system in use. The WLAN devices 10 and 12 include one or more memories 102 and 122 configured to store information including data, instructions, or both. The memory 102 and 122 may be any storage medium accessible by the respective controller 100 and 120, including a read only memory (ROM), a random access memory (RAM), a register, cache memory, semiconductor memory devices, and magnetic media such as internal hard disks and removable disks.

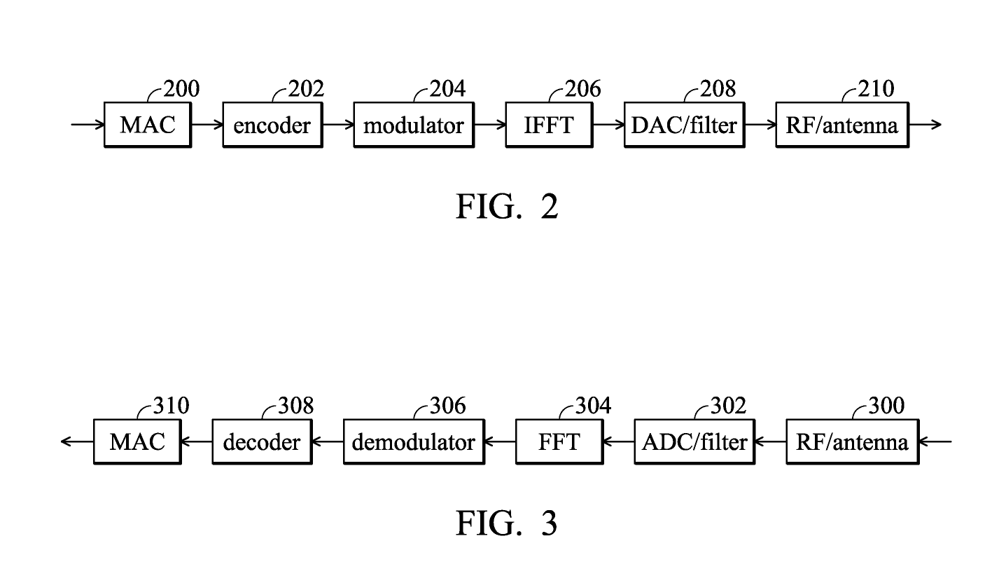

FIG. 2 is a block diagram of an exemplary transmitter 2 in a WLAN device according to an embodiment of the invention, incorporated in the transceiver in the two WLAN devices in FIG. 1. The transmitter 2 can be incorporated in the access point 10 or the mobile communication device 12. The transmitter 2 comprises a MAC module 200, an encoder 202, a modulator 204, an IFFT unit 206, a DAC/filter unit 208, and an RF/antenna unit 210. The MAC module 200 is coupled to the encoder 202, the modulator 204, the IFFT unit 206, the DAC/filter unit 208, and subsequently to the RF/antenna unit 210.

The transmitter 2 can produce outgoing RF signals in one or more frequency ranges to be transmitted over one or more communication channels. The frequency range can include a group of OFDM sub-carriers.

The MAC module 200 may include one or more MAC control units (MCUs) (not shown) to produce and pass MAC protocol Data Units (MPDU), corresponding preamble and header data streams to the encoder 202, which in turn may perform Forward Error Correction encoding thereto to produce respective encoded data stream. Forward Error Correction is also known as channel coding, in which a system adds redundant data providing error control for data transmission to a message to be transmitted. The FEC codes may be a block code or a convolutional code. The block code comprises a fixed size block of symbols. The convolutional code comprises symbol streams of predetermined or arbitrary length. In one implementation, the encoder 202 is a convolutional encoder encoding header data sequence using the convolutional code. The modulator 204 performs various types of modulation schemes on the encoded data streams according to the data type to produce modulated data streams to the Inverse Fast Fourier Transform (IFFT) module 206. The modulation schemes comprise Phase-Shift Keying (PSK), a Frequency Shift Keying (FSK), an Amplitude Shift Keying (ASK), and a Quadrature Amplitude Modulation (QAM). In some implementations, the IFFT module 206 may further include an OFDMA module (not shown), where the OFDMA module maps different modulated streams to different subcarrier groups before IFFT processing. In some implementations, the IFFT module 206 may perform an IFFT on one or more outputs of the modulator 204 to generate one or more time domain signals associated with one or more frequency range. In some implementations, the IFFT module 206 is configured to use one or more FFT bandwidth frequencies such as 20 MHz, 40 MHz, 80 MHz, or 160 MHz. In some implementations, the IFFT module 206 may perform different IFFTs on the modulated data streams according to different FFT bandwidths. Next, the DAC/filter module 208 converts the time domain signal to an analog signal and shapes the analog signal for transmission via the RF/antenna module 210. The RF/antenna module 210 comprises one or more up converters (not shown) that up-convert the analog signals to corresponding frequency bands for the transmitter antennas (not shown) to perform transmission. In some implementations, the RF/antenna module 210 is a built-in unit that is an integral part of the transmitter 2. In some other implementations, the RF/antenna module 210 is a detachable unit that is external to the transmitter 2.

The transceiver 2 may include one or more integrated circuits (ICs) that implement the functionality of multiple units and/or modules including the MAC control unit, baseband unit, or analog unit. In some implementations, the transmitter 2 comprises a controller or a processor that generates the MPDU and the corresponding header module to generate a physical layer protocol data unit (PPDU) for transmission. In some implementations, the controller or processor includes the MAC module 200.

FIG. 3 is a block diagram of an exemplary receiver 3 in a WLAN device according to an embodiment of the invention, incorporated in the transceiver in the two WLAN devices in FIG. 1. The receiver 3 can be incorporated in the access point 10 or the mobile communication device 12. The transmitter 3 comprises an RF/antenna unit 300, an ADC/filter unit 302, a FFT unit 304, a demodulator 306, a decoder 308, and a MAC module 310. The RF/antenna unit 300 is coupled to the ADC/filter unit 302, the FFT unit 304, the demodulator 306, the decoder 308, and then to the MAC module 310.

The receiver 3 receives incoming RF signals in one or more frequency range over one or more communication channels. The frequency range can include a group of OFDM sub-carriers. The receiver 3 performs signal processes to received data packets in a reverse order to the transmitter 2 to recover the information therein. The receiver 3 is capable of detecting a data type of various WLAN generations including IEEE 802.11a/b/g (legacy), IEEE 802.11n, IEEE 802.11ac, or a future WLAN generation based on the signal field in the received data packet. For simplicity of explanation, the next generation IEEE 802.11 PHY/MAC layer will be referred to as “future-generation”, hence forth.

The RF/antenna 300 retrieves the incoming transmission signal comprises the PPDU, performs down-conversion thereon. The ADC/filter unit 302 filters the down-converted signal and transforms which into digital data sequence. The FFT unit 304 in turn transforms the digital data sequence to a frequency domain data sequence. The demodulator 30 determines the modulation type of the symbols in the frequency domain data sequence, thereby determining the WLAN generation of the received data, and demodulates the payload data field

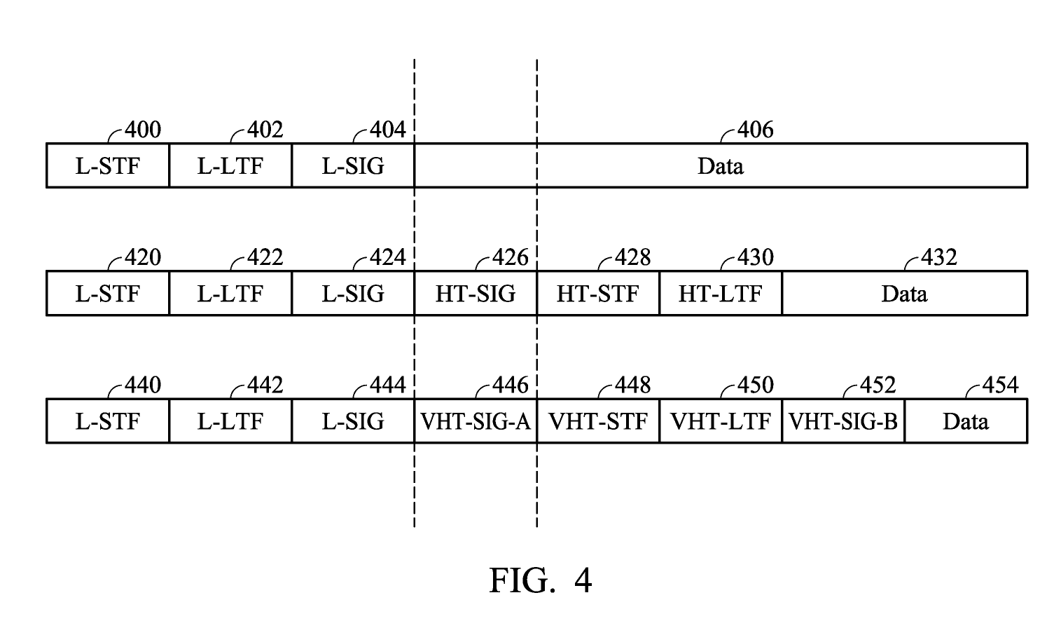

FIG. 4 shows physical layer protocol data formats conforming to legacy 802.11, 802.11n, and 802.11ac specifications along with their timing relationship. The PPDU conforming to legacy 802.11 WLAN specification comprises fields 400-406, the PPDU conforming to 802.11n specification comprises fields 420-432, and the PPDU conforming to current 802.11ac comprises field 440-454. With respect to FIG. 4, all physical layer protocol data formats include three components, namely, a preamble field, a header field and a payload field. The preamble field has one or more training sequences which allow the receiving WLAN device to make measurements which it uses to acquire timing and frequency synchronization and to compensate for effects introduced by the RF/analog circuitry and the propagation channel. Once the receiving WLAN device has processed the preamble it will be able to detect the header and payload portions of the packet. The header field typically carries information about the payload, including its length, the modulation and coding applied to it etc. The header field has a fixed number of bits, which is substantially smaller than the number of bits contained in the payload. The header field is required to be encoded modulated significantly more robustly than the payload field. The payload field may include a service field, a scrambled physical layer service data unit (PSDU), tail bits, and padding bits, when required.

In the WLAN system, the preamble and header fields play a key role in ensuring coexistence of multiple generations of WLAN technologies. The WLAN device is able to identify the generation of the WLAN technology by detecting a modulation type of the header field.

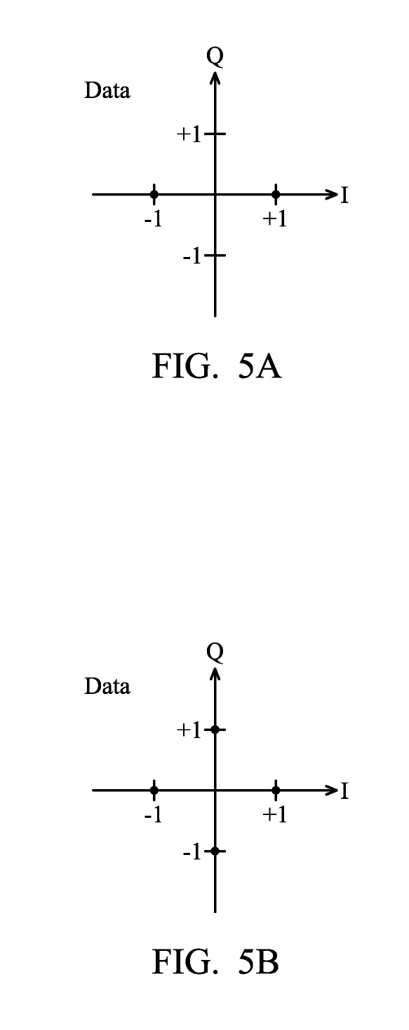

Refer to the fields 400-406, depicting a physical layer protocol data format conforms to the legacy IEEE 802.11a/b/g Standard and occupies a 20 Megahertz (MHz) band. The PPDU includes a preamble field having the legacy short training field (L-STF) 400, the legacy long training field (L-LTF) 402, and the legacy signal field (L-SIG) 404. The PPDU also includes the payload data segment 406 modulated by Binary PSK or QPSK illustrated by FIGS. 5A and 5B respectively.

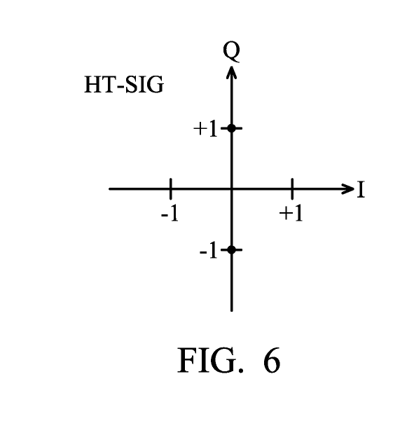

Now refer to the fields 420-432, depicting a physical layer protocol data format conforms to the IEEE 802.11n Standard and occupies a 20 MHz or 40 MHz band for a mixed mode transmission, in which the 802.11n transmission may be embedded in an 802.11a or 802.11g transmission. The physical layer data unit comprises a legacy preamble field having the L-STF 420, the L-LTF 422, the L-SIG 424, a header filed having the high throughput signal field (HT-SIG) 426, the high throughput short training field (HT-STF) 428, and the high throughput long training fields (HT-LTFs) 430. The PPDU also has the payload data segment 432 that carries the payload data. The HT-SIG 426 is QBPSK modulated over two OFDM symbols as illustrated in FIG. 6.

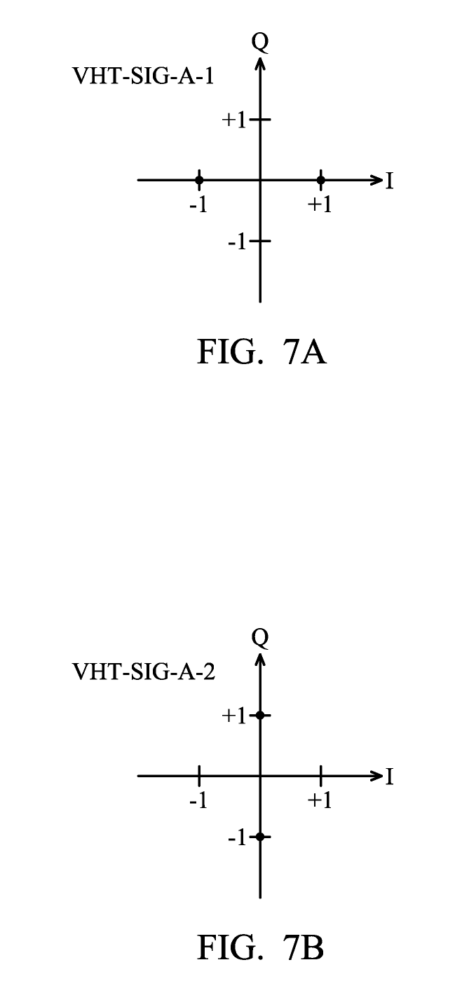

Next refer to the fields 440-454, depicting a physical layer protocol data format conforms to the IEEE 802.11ac Standard. The physical layer data unit comprises a preamble having the L-STF 440, the L-LTF 442, the L-SIG 444, a header field having the very high throughput signal field A (VHT-SIG-A) 446, the very high throughput short training field (VHT-STF) 448, the very high throughput long training field (VHT-LTF) 450, and the VHT-SIG-B 452, and a payload field consisting of the payload data fields (HT-LTFs) 454. The VHT-SIG-A 446 comprises two OFDM symbols modulated by BPSK and QBPSK as illustrated in FIGS. 7A and 7B. The first symbol VHT-SIG-A-1 is modulated by BPSK, and the second symbol VHT-SIG-A-2 is modulated by QBPSK, i.e., the symbol symbol VHT-SIG-A-2 is only on the quadrature axis. The transmission compliant with IEEE 802.11ac standard may occupy 40 MHz, 80 MHz, 120 MHz, or 160 MHz bandwidth. The bandwidth information of the transmission is included in the VHT-SIG-A 446. The VHT-SIG-A field 446 may further contain group of ID information that includes a number of VHT-LTFs and stream numbers to decode for each mobile station. Other modulation types may also be used in 802.11 ac, namely 16-QAM, 64-QAM and 256-QAM.

The L-STF, L-LTF and L-SIG are legacy preamble components and are used to ensure backward compatibility by the WLAN 11n and 11ac generations. The HT-SIG 426 carries the physical layer header in the WLAN 11n systems, whereas the VHT-SIG-A 446 and the VHT-SIG-B 452 carry physical layer header information in the WLAN communication systems. The (V)HT-STF and (V)HT-LTF fields are used for signal acquisition and channel estimation purposes in the WLAN 11n or 11ac systems. Upon receiving a transmission signal carrying a data packet, the WLAN device is able to determine the received data unit belonging to the legacy 802.11a/b/g, 802.11n, or 802.11 ac data packet by identifying and comparing the modulation type of the OFDM symbol successive to the legacy preamble component L-SIG. If the OFDM symbol successive to the field L-SIG is QBPSK modulated, the WLAN receiver determines the received data packet conforms to 802.11n, if the two OFDM symbols successive to the field L-SIG are BPSK then QBPSK modulated, the WLAN receiver determines the received data packet conforms to 802.11ac, otherwise the received data packet is determined as the legacy WLAN data.

For the next generation of WLAN technology after IEEE 802.11n, the future generation data format is provided in the invention to be used to distinguish from preceding generation including the legacy 802.11a/b/g, 802.11n, or 802.11ac.

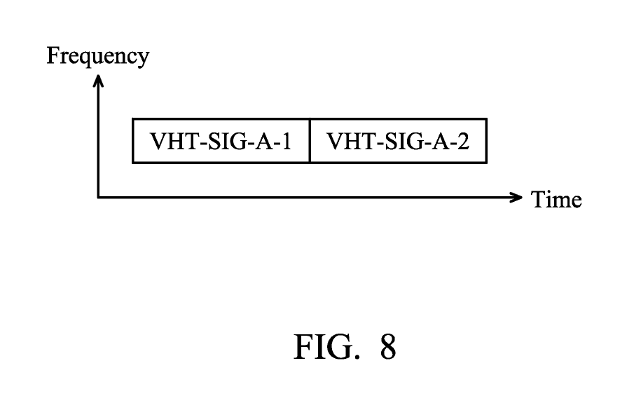

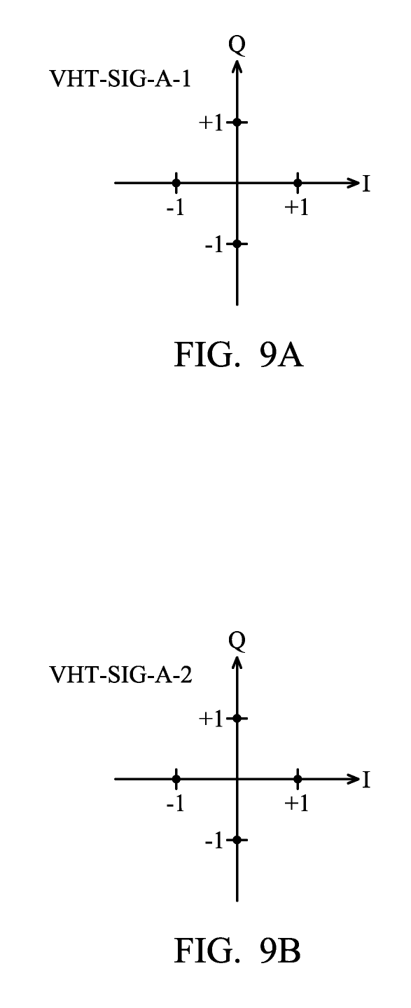

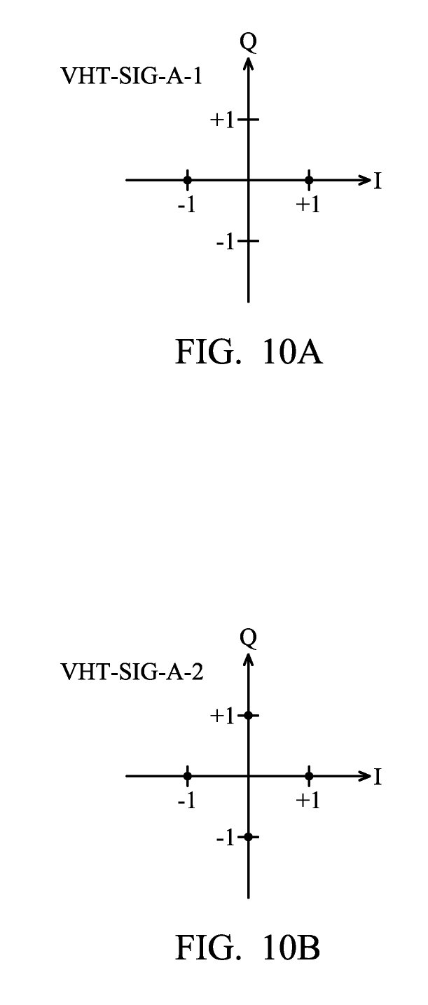

FIG. 8 shows a data format the for the header field VHT-SIG-A conforming to the 802.11 future generation specification according to the invention, where the horizontal axis represents time and the vertical axis represents frequency. The header field VHT-SIG-A 8 comprises two OFDM symbols, denoted by VHT-SIG-A-1 and VHT-SIG-A-2 respectively. The header field 8 comprises bandwidth information for transmission of the data unit. The VHT-SIG-A 8 is modulated in a way such that a receiving WLAN device can distinguish the 802.11 ac data packet from legacy 802.11a/b/g or 802.11n data packet. In some other implementations, the modulator in the WLAN device can split a header data sequence in two and modulate both the first and second parts thereof by S-QPSK, as depicted in FIGS. 9A and 9B, thereby generating two OFDM symbols of the header field for transmission. In some implementations, the modulator in the WLAN device can split a header data sequence in two and modulate the first part thereof by BPSK modulation and the second part thereof by S-QPSK, as depicted in FIGS. 10A and 10B, thereby generating two OFDM symbols of the header field for transmission. Upon reception, the WLAN device receives a data unit comprising the header field 8 and detects the type of the data packet by demodulating the VHT-SIG-A-1 and VHT-SIG-A-2. If the demodulator detects the first OFDM symbol VHT-SIG-A-1 is QBPSK modulated, then a 802.11n data packet is determined. Else in the case the VHT-SIG-A-1 and VHT-SIG-A-2 are both modulated by S-QPSK, the demodulator further detects whether the first OFDM symbol VHT-SIG-A-1 is S-QPSK modulated. If so, the WLAN determines the received data unit is a 802.11 data packet for future generation.

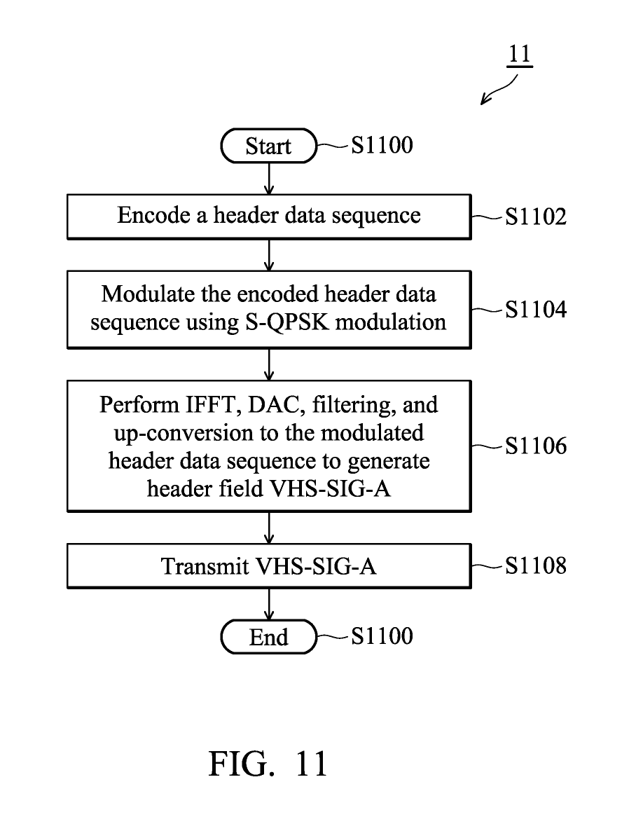

FIG. 11 is a flowchart of an exemplary PPDU generation method 11, generating the header field VHT-SIG-A in the PPDU conforming to the 802.11 future generation specification by a WLAN device according to an embodiment of the invention. The WLAN device may be an access point or a mobile station. The data generation method 11 may incorporate the transmitter 2 in FIG. 2.

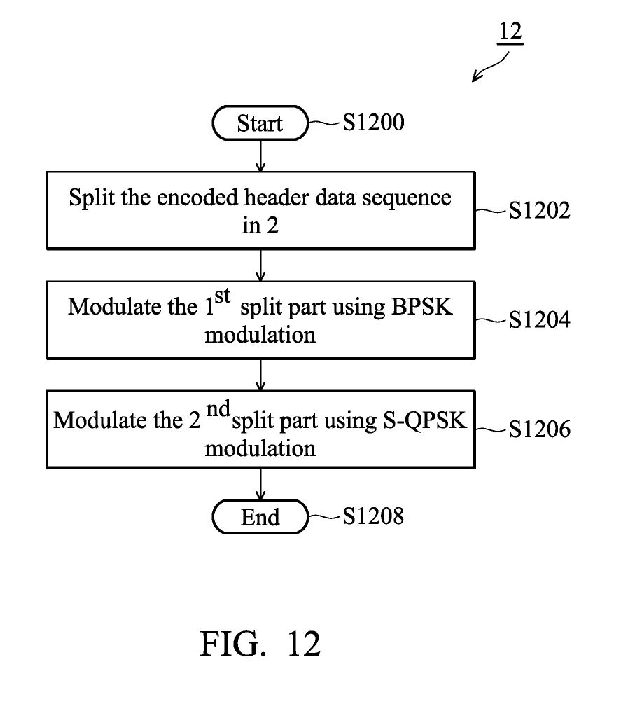

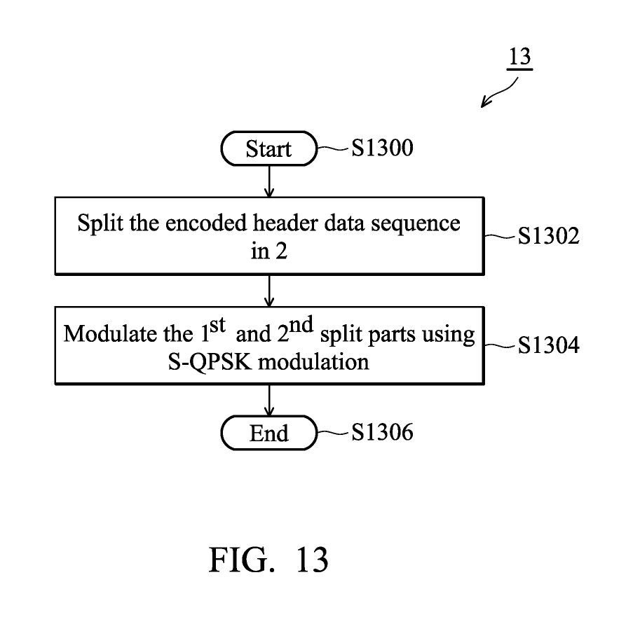

Upon startup (S1100), the MAC module 200 produces a MPDU by attaching MAC Service Data Units (MSDU) from a Logic Link Control (LLC) layer to a MAC header and a Frame Check Sequence (FCS) trailer. The MPDU in conjunction with a physical layer convergence procedure (PLCP) preamble data sequence, header data sequence, tail bits and pad bits are incorporated together to generate an information data sequence to the encoder 202. For simplicity, only the header data sequence is discussed hereafter. Let b=[b₀, b₁, b₂, b₃, . . . , b_{K-1}] denote the header data sequence to be carried by in the VHT-SIG-A. The header data sequence carries physical layer related information such as the bandwidth used for transmission. In Step S1102, the bit sequence b is encoded by the encoder 202 using a channel code (Forward Error Correction), such as a convolutional code, into a N-length bit sequence c=[c₀, c₁, c₂, c₃, . . . , c_{N-1}]. Here N=2L, where L denotes that number of data subcarriers per OFDM symbol. Note that in the case of, convolutional coding with zero padding trellis termination, the data sequence b is assumed to be zero-padded. The encoded sequence c is split into two L-length segments, C1 and C2 and passed to the modulator 204 to perform S-QPSK modulation thereto (S1104), so that the receiving WLAN device can distinguish the 802.11 future generation data packet from the 802.11a/b/g/n data packet. In some implementations, the modulator 204 modulates the first and second encoded data sequences C1 and C2 with the BPSK and the S-QPSK respectively, as shown the flowchart in FIG. 12. In some other implementations, the modulator 204 modulates both the split data segments C1 and C2 with the S-QPSK modulation, as detailed in the flowchart in FIG. 13. The S-QPSK is explained in detail in the modulation method 12. The modulated data sequence is then passed to the IFFT unit 206 for transformation to the time domain signal, which is then processed by the DAC/filter unit 208 for analog signal conversion and processing, and subsequently to the RF/antenna unit 210 to perform up-conversion for transmission (S1106). The PPDU generation method 11 is then completed and exited at Step S1108.

FIG. 12 is a flowchart of an exemplary modulation method 12, performing modulation to the header field VHT-SIG-A by a WLAN device according to an embodiment of the invention. The modulation method 12 may incorporate the transmitter 2 in FIG. 2 and may be incorporated in Step S1104 in the PPDU generation method 11.

Upon startup (S1200), the modulator 204 is initiated to receive the encoded data sequence c from the encoder 202, split the data sequence c in two equal sized, L-length segments, C1 and C2 (S1202). In Step S1204, the sequence C1, consisting of bits C1=[c₀, c₁, c₂, . . . , c_{L-1}] is Binary Phase Shift Keying (BPSK) modulated into a symbol sequence R=[r₀, r₁, r₂, . . . , r_{L-1}] given by:

$${r}_{i} = \{ \begin{matrix}- 1 & if {c}_{i} = 1 \\ + 1 & if {c}_{i} = 0\end{matrix} \qquad ( 1 )$$

for i=0, 1, 2 . . . , L−1.

Next in Step S1206, the data sequence C2, consisting of bits C2=[c_{L}, c_{L+1}, c_{L+2}, . . . , c_{2L-1}] is Spread Quaternary Phase Shift Keying (S-QPSK) modulated into a symbol sequence S=[s_{1,0}, s_{1,1}, s_{1,2}, . . . , s_{1,L/2-1}, s_{2,0}, s_{2,1}, s_{2,2}, . . . , s_{2,L/2-1}] where:

$$\begin{matrix}{s}_{1 , i} = \{ \begin{matrix}\frac{1}{\sqrt{2}} ( + 1 + j ) & if {c}_{L + 2 i} = 0 and {c}_{L + 2 i + 1} = 0 \\ \frac{1}{\sqrt{2}} ( - 1 + j ) & if {c}_{L + 2 i} = 1 and {c}_{L + 2 i + 1} = 0 \\ \frac{1}{\sqrt{2}} ( + 1 - j ) & if {c}_{L + 2 i} = 0 and {c}_{L + 2 i + 1} = 1 \\ \frac{1}{\sqrt{2}} ( - 1 - j ) & if {c}_{L + 2 i} = 1 and {c}_{L + 2 i + 1} = 1\end{matrix} \\ and & ( 2 ) \\ {s}_{2 , i} = conjugate ⌊ {s}_{1 , i } ⌋ & ( 3 )\end{matrix}$$

for i=0, 1, 2 . . . , L/2−1.

The symbol sequence [s_{1,0}, s_{1,1}, s_{1,2}, . . . s_{1,L/2-1}] is paired with the symbol sequence [s_{2,0}, s_{2,1}, s_{2,2}, . . . , s_{2,L/2-1}], each set of paired symbols contain the same information therein, with one being a conjugate of another. Each paired symbols are transmitted over separate sub-carriers to reduce effects of multipath and fading in the telecommunication environment and increase robustness of telecommunication to a temporary deep fading. The two sub-carriers carrying each symbol pair may be separated by a constant frequency offset. The modulation method 12 is then completed and exited at Step S1208.

FIG. 13 is a flowchart of another exemplary modulation method 13, performing modulation to the header field VHT-SIG-A by a WLAN device according to an embodiment of the invention. The modulation method 13 may incorporate the transmitter 2 in FIG. 2 and may be incorporated in Step S1104 in the PPDU generation method 11.

Similar to the modulation method 12, after initialization (S1300), the modulator 202 divides the encoded data sequence in two to produce the header data sequence C1 and C2 (S1302). The modulator 202 then performs S-QPSK modulation according to Equation (2) and Equation (3) to both the header data sequence C1 and C2 to produce two OFDM symbols for the VHT-SIG-A-1 and VHT-SIG-A-2 fields. Each OFDM symbol comprises two sub-symbols comprising the same information therein, with one being a conjugate of another. Like the method 12, each paired symbols are transmitted over separate sub-carriers to reduce effects of multipath and fading in the telecommunication environment and increase robustness of telecommunication to a temporary deep fading. The two sub-carriers carrying each symbol pair may be separated by a constant frequency offset. The modulation method 13 is then completed and exited at Step S1308.

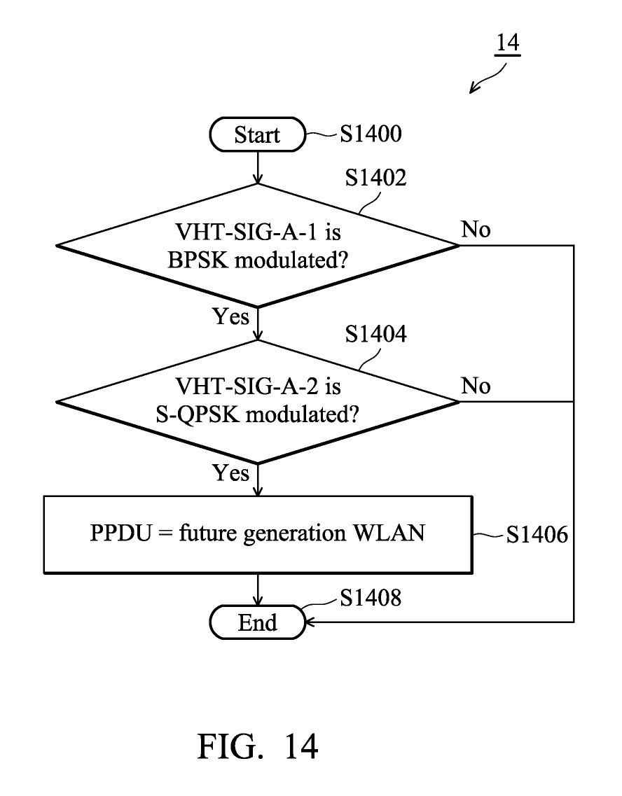

FIG. 14 is a flowchart of an exemplary data type detection method 14, performing demodulation to the header field VHT-SIG-A by a WLAN device according to an embodiment of the invention. The WLAN device may be an access point or a mobile station. The demodulation method 14 may incorporate the transmitter 3 in FIG. 3.

Upon startup of the data type detection method 14, the RF/antenna unit 300 retrieves a transmission signal that includes a physical layer protocol data unit from the air (S1400). The WLAN device, able to recognize the future generation data packet format, is required to determine the data format, i.e., WiFi generation, of the packet being received. The determination of the WiFi generation is done by detecting the modulation format of the header field. A symbol detector in the WLAN device is employed to determine the type of modulation employed in the VHT-SIG-A-1 and VHT-SIG-A-2 field. The symbol detector may be the demodulator 306 in FIG. 3, and comprises an energy detector (not shown) comparing the energy in the in-phase component of the signal against the energy in the quadrature component. The symbol detector determines whether the first header symbol VHT-SIG-A-1 is BPSK modulated (S1402). If so, the symbol detector continues to determine whether the next header symbol VHT-SIG-A-2 is SQPSK modulated (S1404), and if otherwise, the symbol detector determines the received data packet is not for the future generation WLAN and the method 14 exits (S1408). If the symbol detector further detects that the second header symbol VHT-SIG-A-2 is SQPSK modulated, the symbol detector then determines the received data packet conforms to the future generation WLAN standard (S1406), otherwise the received data packet is not compliant with the future generation WLAN standard and the method 14 is exited at Step S1408. The data type detection method 14 is completed and exited at Step S1408. In some implementations, the symbol detector comprises a BPSK symbol detector and a SQPSK detector. When the BPSK detector detects the BPSK modulation is present in the first OFDM symbol VHT-SIG-A-1 and absent from the second OFDM symbol VHT-SIG-A-2, the SQPSK detects the SQPSK modulation is absent from the first OFDM symbol VHT-SIG-A-1 and present in the second OFDM symbol VHT-SIG-A-2, or a combination thereof, the symbol detector may determine that the data packet belongs to the WLAN communication protocol for the future generation.

The BPSK modulation may be detected by comparing the energy along the horizontal axis (in-phase component) with the energy along the vertical axis (quadrature component). When the energy on the horizontal axis exceeds the energy on the vertical axis, the symbol detector determines the OFDM symbol is BPSK modulated. Conversely, when the energy on the vertical axis exceeds the energy on horizontal axis, the symbol detector determines a QBPSK modulated symbol.

Detecting the SQPSK modulation, in the presence of thermal noise and frequency selective fading can be done as follows. Assume x_{1,i} and x_{2,i} are the equalized received signals corresponding to the transmitted SQPSK symbol pair. s_{1,i}, s_{2,i}. First a metric, κ is generated as:

$$κ = {\sum }_{i}^{ } sign ( {r}_{1 , i} ) sign ( {r}_{2 , i} ) min ( \vert {r}_{1 , i} \vert , \vert {r}_{2 , i} \vert ) - {\sum }_{i}^{ } sign ( {q}_{1 , i} ) sign ( {q}_{2 , i} ) min ( \vert {q}_{1 , i} \vert , \vert {q}_{2 , i} \vert ) \qquad ( 4 )$$

where

r_{1,i}=real(s_{1,i})

r_{2,i}=real(s_{2,i})

q_{1,i}=imag(s_{1,i})

q_{2,i}=imag(s_{1,i})

A positive value of the metric κ indicates S-QPSK modulation. The more positive the metric, the likelihood of SQPSK modulation has been employed is higher. Alternatively, a simpler metric can be used. The simpler metric, denoted κₛ is defined as:

$${κ}_{s} = {\sum }_{i}^{ } sign ( {r}_{1 , i} ) sign ( {r}_{2 , i} ) - {\sum }_{i}^{ } sign ( {q}_{1 , i} ) sign ( {q}_{2 , i} ) \qquad ( 5 )$$

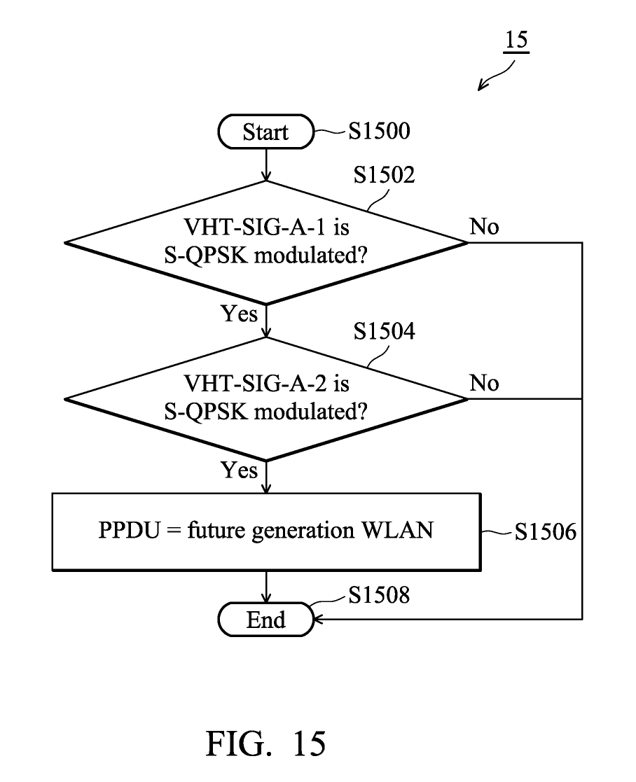

FIG. 15 is a flowchart of another exemplary data type detection method 15, performing demodulation to the header field VHT-SIG-A by a WLAN device according to an embodiment of the invention. The WLAN device may be an access point or a mobile station. The data type detection method 15 may incorporate the transmitter 3 in FIG. 3. The data type detection method 15 is identical to the method 14, except both the first and second header symbols VHT-SIG-A-1 and VHT-SIG-A-2 are checked for the SQPSK modulation (S1502, S1504), and only when both the header symbols are SQPSK modulated, the symbol detector determine the received data packet being the future generation WLAN packet.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A Wireless Local Area Network (WLAN) device, generating a Physical Layer (PHY) protocol data unit (PPDU) comprising a preamble field, a header field and a payload field for transmission, comprising:
a MAC module, generating a header data sequence comprising bandwidth information of the transmission;
a modulator, modulating the header data sequence using spread QPSK (S-QPSK) modulation to generate the header field of the PPDU; and
an RF module, transmitting the header field.

2. The WLAN device of claim 1, wherein the modulator splits the header data sequence in two parts, and modulates the two parts using the S-QPSK modulation to generate two OFDM symbols.

3. The WLAN device of claim 1, wherein the modulator splits the header data sequence to generate a first part and a second part, and modulates the first part using BPSK modulation to generate a first OFDM symbol of the header field and the second part using the S-QPSK modulation to generate the second OFDM symbol of the header field.

4. The WLAN device of claim 1, wherein the modulator modulates the header data sequence using the spread QPSK modulation to generate an OFDM symbol comprising first and second sub-symbols, each is transmitted on a separate sub-carrier.

5. The WLAN device of claim 4, wherein the RF module transmits the first and second sub-symbols on the two sub-carriers separated by a constant frequency offset.

6. The WLAN device of claim 4, wherein the second sub-symbol is a conjugate of the first sub-symbol.

7. The WLAN device of claim 1, further comprising an encoder, encoding the header data sequence in a single Forward Error Correction (FEC) code block.

8. The WLAN device of claim 1, further comprising an encoder, encoding the header data sequence in a convolutional code block.

9. A WLAN device, receiving data transmission of a Physical Layer (PHY) protocol data unit (PPDU) comprising a preamble field, a header field and a payload field, comprising:
an RF module, receiving the PPDU comprising the header field, wherein the header field comprises bandwidth information of the data transmission; and
a symbol detector, determining whether the header field is S-QPSK modulated, and determining the PPDU conforms to a WLAN communication protocol when the header field is S-QPSK modulated.

10. The WLAN device of claim 9, wherein the header field comprises two OFDM symbols, and the symbol detector determines the PPDU conforms to the WLAN communication protocol when the two OFDM symbols are S-QPSK modulated.

11. The WLAN device of claim 9, wherein the header field comprises two OFDM symbols, and the symbol detector determines the PPDU conforms to the WLAN communication protocol when one OFDM symbol in the header field is BPSK modulated, and the other OFDM symbol in the header field is S-QPSK modulated.

12. The WLAN device of claim 9, wherein the header field comprises two OFDM symbols, and the symbol detector determines the PPDU conforms to the WLAN communication protocol when detecting one OFDM symbol in the header field is BPSK modulated, and the other OFDM symbol in the header field is in absence of the BPSK modulation.

13. The WLAN device of claim 9, wherein the header field comprises an OFDM symbol having two sub-symbols, and the RF modules receives the two sub-symbols on two separate sub-carriers.

14. The WLAN device of claim 12, wherein the RF module receives the two sub-symbols on the two sub-carriers separated by a constant frequency offset.

15. The WLAN device of claim 12, wherein one of the two sub-symbols is a conjugate of the other sub-symbol.

16. The WLAN device of claim 9, further comprising a decoder, decoding the header field using Forward Error Correction (FEC).

17. The WLAN device of claim 9, further comprising a decoder, decoding the header data sequence using Viterbi decoding.

18. A method, generating a Physical Layer (PHY) protocol data unit (PPDU) comprising a preamble field, a header field and a payload field for transmission by a WLAN device, comprising:
a MAC module generating a header data sequence comprising bandwidth information of the transmission;
a modulator modulating the header data sequence using S-QPSK modulation to generate the header field of the PPDU; and
an RF module transmitting the header field.

19. The method of claim 18, further comprising the modulator splitting the header data sequence in two parts, and wherein the modulating step comprises the modulator modulating the two parts using the S-QPSK modulation to generate two OFDM symbols.

20. The method of claim 18, further comprising the modulator splitting the header data sequence to generate a first part and a second part, and wherein the modulating step comprises the modulator modulating the first part using BPSK modulation to generate to generate a first OFDM symbol of the header field and the second part using the S-QPSK modulation to generate the second OFDM symbol of the header field.

21. The method of claim 18, wherein the modulating step comprises the modulator modulating the header data sequence using the S-QPSK modulation to generate an OFDM symbol comprising first and second sub-symbols, each is transmitted on a separate sub-carrier.

22. The method of claim 21, wherein the transmitting step comprises the RF module transmitting the first and second sub-symbols on the two sub-carriers separated by a constant frequency offset.

23. The method of claim 21, wherein the second sub-symbol is a conjugate of the first sub-symbol.

24. The Method of claim 18, further comprising an encoder encoding the header data sequence in a single Forward Error Correction (FEC) code block.

25. The method of claim 18, further comprising an encoder encoding the header data sequence in a convolutional code block.

26. A method, receiving data transmission of a Physical Layer (PHY) protocol data unit (PPDU) comprising a preamble field, a header field and a payload field by a WLAN device, comprising:
an RF module receiving the PPDU comprising the header field, wherein the header field comprises bandwidth information of the data transmission;
a symbol detector determining whether the header field is S-QPSK modulated; and
the symbol detector determining the PPDU conforms to a WLAN communication protocol when the header field is S-QPSK modulated.

27. The method of claim 26, wherein the header field comprises two OFDM symbols, and the determining the PPDU conforms to the WLAN communication protocol step comprises the symbol detector determining the PPDU conforms to the WLAN communication protocol when the two OFDM symbols are S-QPSK modulated.

28. The method of claim 26, wherein the header field comprises two OFDM symbols, and the determining the PPDU conforms to the WLAN communication protocol step comprises the symbol detector determining the PPDU conforms to the WLAN communication protocol when one OFDM symbol in the header field is S-QPSK modulated, and the other OFDM symbol in the header field is BPSK modulated.

29. The method of claim 26, wherein the header field comprises two OFDM symbols, and the determining the PPDU conforms to the WLAN communication protocol step comprises the symbol detector determining the PPDU conforms to the WLAN communication protocol when detecting one OFDM symbol in the header field is BPSK modulated, and the other OFDM symbol in the header field is in absence of the BPSK modulation.

30. The method of claim 26, wherein the header field comprises an OFDM symbol having two sub-symbols, and the receiving step comprises the RF modules receiving the two sub-symbols on two separate sub-carriers.

31. The method of claim 30, wherein the receiving step comprises the RF module receiving the two sub-symbols on the two sub-carriers separated by a constant frequency offset.

32. The method of claim 30, wherein one of the two sub-symbols is a conjugate of the other sub-symbol.

33. The method of claim 26, further comprising a decoder decoding the header field using Forward Error Correction (FEC).

34. The method of claim 26, further comprising a decoder decoding the header data sequence using Viterbi decoding.
